(19) United States
(12) Patent Application Publication
(10) Pub. No.: US 2026/0329829 A1
(43) Pub. Date: Oct. 22, 2026

(54) SYSTEM AND METHOD FOR A STATEFUL, VERIFIABLE, AND COMPOSABLE ARTIFICIAL INTELLIGENCE OPERATING SYSTEM USING PERSISTENT WORLD VIEW OBJECTS

(71) Applicant: Bell Innovative Technology, LLC, Frisco, TX (US)

(72) Inventors: Richard Wayne Bell, Frisco, TX (US); Ralph A. Smith, Frisco, TX (US); Sundar Padmanabhan, Frisco, TX (US)

(21) Appl. No.: 19/640,100

(22) Filed: Apr. 6, 2026

Related U.S. Application Data
(60) Provisional application No. 63/784,744, filed on Apr. 7, 2025.
(60) Provisional application No. 63/881,024, filed on Sep. 12, 2025.

(51) Int. Cl. G06F 16/21; G06F 11/14; G06F 16/2453; G06F 21/31; G06F 21/62

(52) U.S. Cl. CPC G06F 16/219; G06F 11/1402; G06F 16/2453; G06F 21/31; G06F 21/6218

(57) ABSTRACT

A stateful, verifiable, and composable artificial intelligence operating system maintains persistent world view objects representing domain-specific or task-specific state. A world view object may include a seed layer, an input layer, an inference layer, a validation layer, and a trusted state layer, and may be linked to one or more persistent global data views. The system normalizes incoming data, stores reusable prepared state, executes one or more artificial intelligence models, assigns certainty or validation states to outputs, and promotes validated outputs into trusted state. Controllers or agents can be bound to a world view object to perform lookups, validation, workflows, and actions subject to identity, policy, entitlement, and governance rules. World view objects may be inherited and composed to form derived world view objects with preserved lineage and conflict handling. The operating system may execute across cloud, decentralized, and edge nodes with synchronized state, auditable provenance, optional blockchain anchoring, and monetized access control. In certain embodiments, distributed AI validators independently evaluate AI operations and participate in a consensus mechanism before acceptance of model updates, training-state transitions, inference results, automated actions, compensation events, or audit mutations, thereby detecting or preventing manipulated or cheating behavior.

### CROSS REFERENCE TO RELATED APPLICATIONS

This application claims the benefit of U.S. Provisional Application No. 63/784,744, filed Apr. 7, 2025, and U.S. Provisional Application No. 63/881,024, filed Sep. 12, 2025, the disclosures of each of which are hereby incorporated by reference in their entireties as if expressly set forth herein.

### STATEMENT REGARDING FEDERALLY SPONSORED RESEARCH OR DEVELOPMENT

Not applicable.

### FIELD

The present disclosure relates generally to artificial intelligence systems, distributed computing, persistent data orchestration, distributed validation, and verifiable autonomous agent execution. More particularly, the disclosure relates to an artificial intelligence operating system and encapsulation framework that maintains persistent, composable AI world view objects, orchestrates model interactions across distributed networks, records auditable lineage for data, models, state transitions, and agent actions, and uses distributed validator consensus to validate AI operations and detect manipulated or cheating behavior.

### BACKGROUND OF THE DISCLOSURE

Many contemporary AI implementations are effectively stateless. A user request commonly triggers repeated data retrieval, repeated prompt construction, repeated context assembly, and repeated inference against one or more models. This repeated-query architecture increases cost, creates latency, and makes it difficult to maintain consistent context across multiple agents, workflows, and users.

Existing systems also tend to separate model execution from data governance. Data may be fetched from external APIs, enterprise systems, data lakes, or live sensors without retaining a synchronized and reusable state representation that is accessible to later workflows. As a result, different agents can operate on inconsistent data snapshots, outputs can be difficult to reproduce, and source lineage is often incomplete.

Another limitation of current AI ecosystems is that models and agents are frequently siloed. Models developed in different frameworks or delivered by different providers are often manually integrated. It is difficult to route outputs from one model into another model, to discover capabilities dynamically, or to verify how a given inference was produced across a chain of heterogeneous models and services.

Conventional orchestration approaches also fail to address trust and operational certainty. Live streams, enterprise feeds, and user-supplied content may have different verification states, but many systems do not organize model outputs by certainty or validation status. In high-stakes environments such as industrial operations, energy systems, transportation, healthcare operations, and financial decision support, a lack of explicit certainty layering can prevent safe automation.

Distributed and edge AI deployments present further difficulties. Devices, vehicles, industrial equipment, and remote nodes may experience intermittent connectivity, yet still need to perform local inference, receive updated models, and synchronize data and learned state when communications are restored. Existing systems do not provide a unified operating framework that combines persistent state, distributed execution, verification, model composition, and validator-supervised operational integrity.

Current AI systems also generally lack a verifiable and durable mechanism for validating the learning process itself, for validating later inference operations across distributed infrastructure, and for preventing participating nodes, agents, models, or resource providers from falsifying computation, misreporting training or inference results, fabricating audit events, poisoning updates, or otherwise “cheating” the system.

Many existing monetization architectures are similarly fragmented. They do not cleanly connect identity, access rights, entitlement checks, pricing rules, resource allocation, compensation, and cross-rail settlement for AI services across distributed infrastructure. Nor do they preserve complete lineage for payment-linked AI operations.

Accordingly, there remains a need for a system that (i) encapsulates AI context as persistent machine-maintained objects, (ii) integrates base queries, enterprise data, real-time streams, and model outputs into reusable state, (iii) supports inheritance and composition of such state across workflows, (iv) governs access by certified agents and policies, (v) operates across centralized, decentralized, cloud, and edge computing environments with verifiable auditability, and (vi) uses distributed validator consensus to ensure integrity of AI operations.

### SUMMARY OF THE DISCLOSURE

The present disclosure provides an artificial intelligence operating system and AI encapsulation platform in which machine-maintained world view objects represent persistent domain-specific or task-specific state. A world view object may correspond to a market, enterprise process, physical asset, industrial system, vehicle, battery, device fleet, healthcare workflow, logistics region, cybersecurity environment, or any other modeled environment. A world view object may also represent a composite context formed from multiple parent world view objects.

Each world view object may be initialized from a seed set that includes one or more base queries, seed datasets, or outputs produced by one or more external or internal AI models. By way of example and without limitation, the seed set may be generated through connectors to large language models, analytical models, knowledge systems, enterprise data services, retrieval systems, simulation engines, or domain-specific AI models provided by third parties or internal deployments.

After initialization, the world view object is expanded and maintained through multiple layers. In an illustrative embodiment, the object includes a seed layer, an input layer, an inference layer, a validation layer, and a trusted state layer. The input layer can receive real-time streams, scheduled network queries, enterprise feeds, user submissions, application logs, and sensor data from edge devices or industrial assets.

The system normalizes incoming data and organizes the data into persistent, structured, and reusable environments referred to herein as global data views. A global data view may be domain-specific and may be indexed by time, source, region, entity, context, asset class, device group, policy regime, frequency band, or any other parameter. A world view object may reference, embed, or be derived from one or more global data views.

Inference layers of a world view object may include outputs from one or more AI models that are trained, updated, or executed using the seed layer and input layer. Model outputs, hypotheses, controller reasoning, validator observations, and cross-model inferences may be stored in a stateful form rather than being discarded after a single query cycle.

The validation layer organizes outputs by certainty and verification status. Validation may include cross-model checks, source certification, deterministic policy checks, provenance verification, statistical testing, replay against a versioned state, human review, consensus analysis, or any combination thereof. As confidence increases, assertions may be promoted toward the trusted state layer, where higher-certainty facts, policies, action gates, and reusable prepared state are maintained.

Each world view object can be bound to one or more controllers or agents. A controller or agent may perform lookups, schedule tasks, call tools, request additional data, validate assertions, trigger workflows, generate decision memoranda, or initiate actions. In some embodiments, only agents with a required identity, certification level, entitlement, or policy authorization are permitted to access specified portions of a world view object or global data view.

World view objects are storable and reusable. A previously stored world view object may serve as a starting context for a new object. In one embodiment, a derived world view object inherits selected state from a plurality of parent world view objects. The system maintains lineage links among the parent objects and the derived object, and may apply conflict-resolution logic based on recency, source priority, certainty level, policy, jurisdiction, owner preference, or other rules.

The platform may further provide a trust and identity layer, an immutable or non-changeable audit log, and an optional blockchain anchoring service. Users, agents, models, world view objects, data assets, workflows, and validator roles may be assigned unique identifiers and associated permissions. Records of training events, model changes, data mutations, agent actions, payments, state transitions, and validator determinations may be stored in an auditable history. In some embodiments, such identifiers are implemented as immutable digital identifiers anchored to a layer-one blockchain or equivalent trust service.

Execution may occur across centralized servers, cloud environments, containerized clusters, decentralized physical infrastructure networks, edge devices, vehicles, and other heterogeneous nodes. Nodes may operate while connected or disconnected. Local state updates and local inference outputs can be synchronized when connectivity is re-established. The resulting system functions as a stateful AI operating system that improves consistency, efficiency, composability, trust, and operational resilience.

In certain embodiments, the system further provides mechanisms for evaluating programmable governance rules prior to execution of automated actions, initiating workflows autonomously in response to schedules, event triggers, or detected state conditions, allocating computational work across distributed infrastructure resources according to operational characteristics, and maintaining hierarchical and graph-based relationships among persistent world view objects. These capabilities enable coordinated operation of distributed components while preserving validated state relationships and supporting reliable execution of system functions over time.

In certain embodiments, the system determines whether later requests can be satisfied using previously validated state without retrieving new external data. Reuse may depend on a semantic similarity or correspondence metric, validity intervals, change conditions, underlying source updates, or a requested historical time point. When reuse is not permitted, the system may invalidate, refresh, or reconstruct the relevant state before generating a result or authorizing an action.

In certain embodiments, the platform includes a specialized payment service or universal payment agent configured to abstract payment complexity for users and workflows. The payment service may perform cross-rail conversion, cross-chain bridging, token swaps, settlement, internal credit allocation, fiat-denominated pricing conversion, or combinations thereof while maintaining lineage between monetized access decisions and the associated AI operations.

In certain embodiments, the system includes an agentic kernel or cognitive orchestrator that arbitrates access not only to compute resources but also to reasoning capacity, context windows, tool access, validation routes, and distributed services. The agentic kernel may manage one or more agent classes, including meta-agents, supervisor agents, worker agents, and maintenance or janitorial agents, and may coordinate agent-to-agent composition through a dynamic agent mesh.

In certain embodiments, the validation layer includes distributed AI validators that independently review training-state transitions, model updates, inference outputs, resource-consumption reports, audit mutations, or proposed automated actions. The validators may participate in a consensus mechanism before an AI operation is accepted, promoted, compensated, anchored, or permitted to drive downstream action. Such consensus can detect or prevent cheating, including falsified computations, fabricated lineage, poisoned updates, collusive validation, replay inconsistency, model-state tampering, fabricated usage reports, or other manipulated behavior.

### BRIEF DESCRIPTION OF THE DRAWINGS

FIG. 1 is a schematic diagram illustrating a high-level system architecture including a user interface and API gateway, an off-chain execution layer, a distributed resource layer, and a trust and identity layer.

FIG. 2 is a diagram illustrating interoperability of AI models across distributed nodes, including output chaining between models and neuron-level interfacing among heterogeneous models.

FIG. 3 is a flowchart illustrating an example request and orchestration flow for authenticating a request, selecting persistent state, executing one or more models or agents, applying validation and governance, optionally invoking distributed validators, and recording an audit update.

FIG. 4 is a diagram illustrating an identity and governance management arrangement for users, agents, models, validators, and world view objects.

FIG. 5 is a diagram illustrating an example operating platform architecture including ingestion, normalization, persistent state, governance, orchestration, global data views, validation, and multi-model execution services.

FIG. 6 is a diagram illustrating an example layered world view object stack having progressively differentiated certainty and validation across layers, together with controller, agent, and validator interaction.

FIG. 7 is a diagram illustrating composition and inheritance of a derived world view object from multiple parent world view objects.

### DRAWING ELEMENTS AND REFERENCE NUMERALS

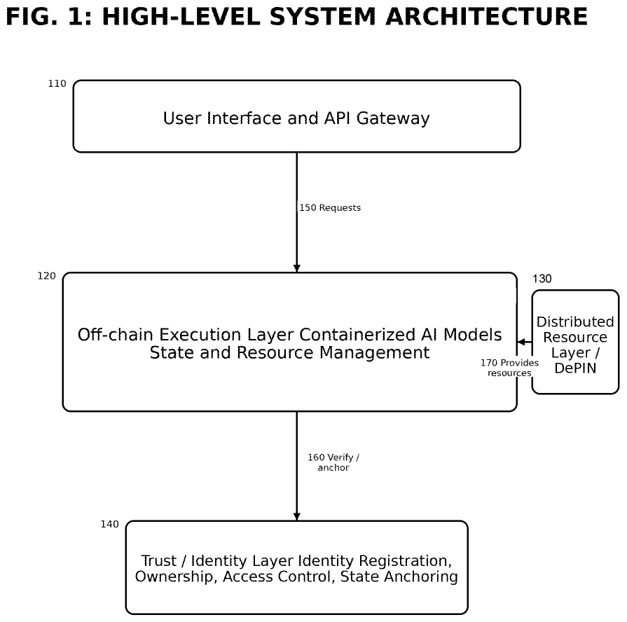

Referring to FIG. 1, system architecture 100 includes a user interface and API gateway 110 communicatively coupled to an off-chain execution layer 120 by request path 150. The off-chain execution layer 120 is communicatively coupled to a trust and identity layer 140 by verify-and-anchor path 160 and to a distributed resource layer 130 by provider resource path 170.

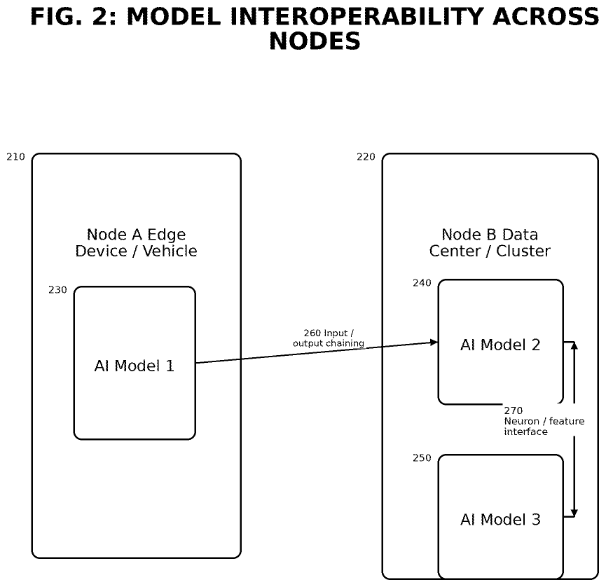

Referring to FIG. 2, interoperability arrangement 200 includes a first node 210 and a second node 220. A first AI model 230 is disposed within the first node 210. A second AI model 240 and a third AI model 250 are disposed within the second node 220. Output chaining path 260 routes output of the first AI model 230 as input to the second AI model 240, and interface 270 communicatively couples the second AI model 240 to the third AI model 250 at a neuron, feature, embedding, latent, point, or layer interface.

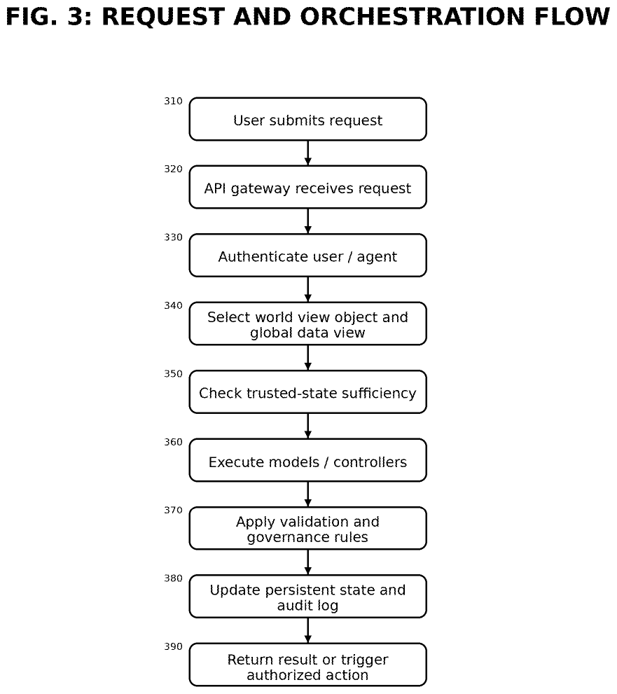

Referring to FIG. 3, flow 300 includes request submission step 310 followed by gateway receive step 320, authentication step 330, world view object and global data view selection step 340, trusted-state sufficiency step 350, model or controller execution step 360, validation and governance step 370, persistent-state and audit update step 380, and response or authorized action step 390. The illustrated arrows represent an example operational sequence.

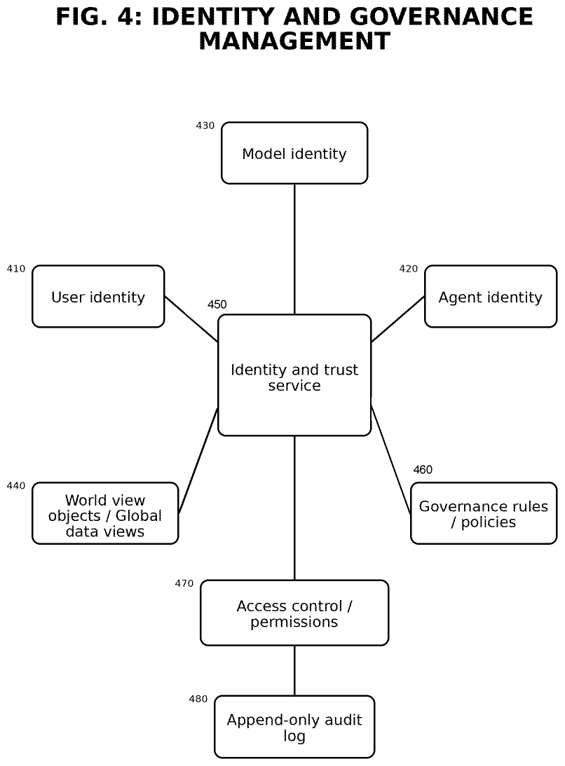

Referring to FIG. 4, identity and governance arrangement 400 includes user identity 410, agent identity 420, model identity 430, and world view object and global data view identities 440, each of which is communicatively coupled to identity and trust service 450. Identity and trust service 450 is further operatively associated with governance rules and policies 460, access control and permissions 470, and append-only audit log 480.

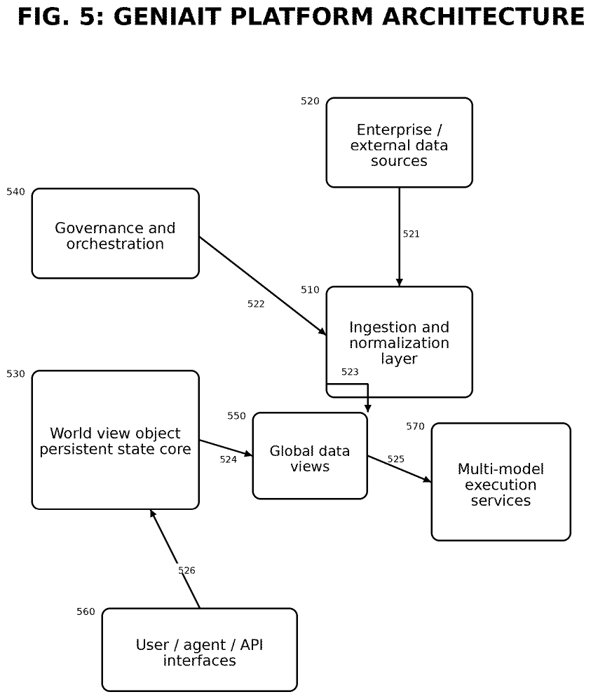

Referring to FIG. 5, platform architecture 500 includes enterprise or external data sources 520 coupled to ingestion and normalization layer 510 by path 521. Governance and orchestration component 540 communicates with ingestion and normalization layer 510 by path 522. Ingestion and normalization layer 510 communicates with global data views 550 by path 523. World view object persistent state core 530 communicates with global data views 550 by path 524 and with user, agent, and API interfaces 560 by path 526. Global data views 550 communicate with multi-model execution services 570 by path 525.

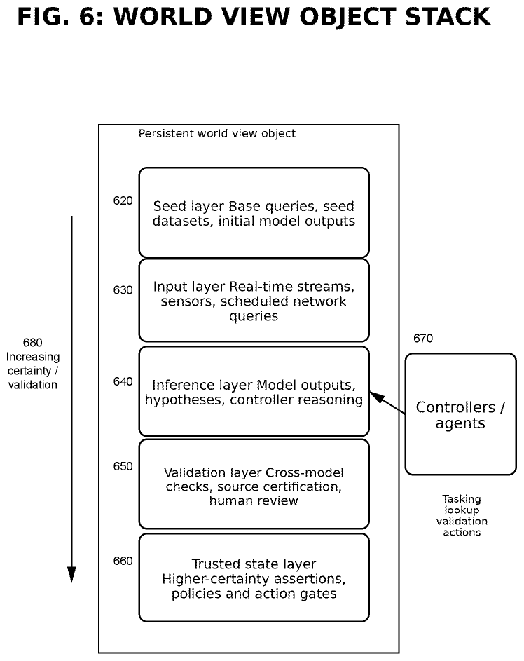

Referring to FIG. 6, world view object stack 600 includes a persistent world view object 610 containing seed layer 620, input layer 630, inference layer 640, validation layer 650, and trusted state layer 660. Controller or agent block 670 is operatively coupled to the stack 600, and progression indicator 680 denotes increasing certainty or validation across the illustrated layers.

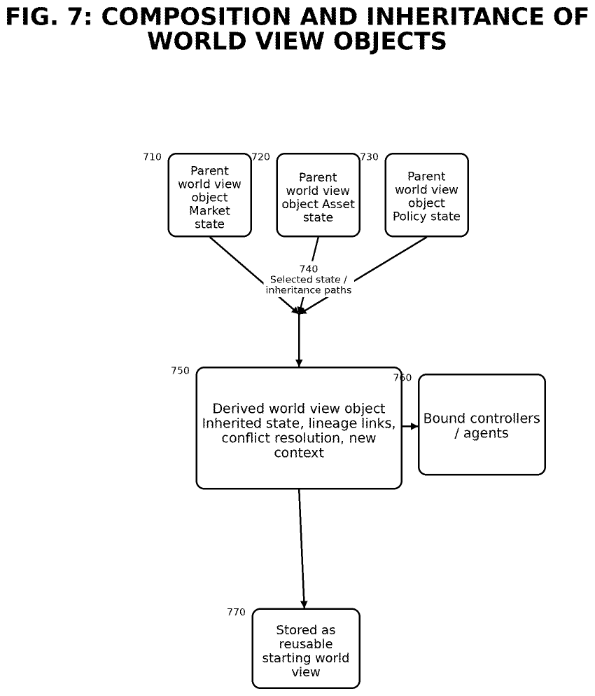

Referring to FIG. 7, composition and inheritance arrangement 700 includes parent world view objects 710, 720, and 730 coupled by selected-state inheritance paths 740 to derived world view object 750. Derived world view object 750 is operatively coupled to bound controllers or agents 760 and to reusable stored derived object 770.

### DETAILED DESCRIPTION OF ILLUSTRATIVE EMBODIMENTS

In the following description, numerous specific details are set forth to provide an understanding of illustrative embodiments of the disclosure. It will be understood, however, that the disclosed subject matter can be practiced without every specific detail described herein, and that the described embodiments are non-limiting.

As used herein, a “world view object” refers to an encapsulated, machine-maintained state object representing a current computed understanding of a domain, asset, device, process, environment, market, enterprise context, or combination thereof. A world view object can include raw inputs, normalized data, inferred assertions, validation metadata, policies, action permissions, controller bindings, validator observations, and lineage links.

As used herein, a “global data view” refers to a persistent, structured, and reusable data environment that is organized for repeated access by one or more models, agents, validators, or workflows. A global data view may provide a synchronized source of truth for a domain or sub-domain and may be updated independently of any specific user query.

As used herein, a “controller” or “agent” refers to software logic capable of interacting with one or more world view objects, global data views, models, tools, validators, or workflows in order to perform a task, lookup, validation, routing operation, decision-support function, or action. Controllers may be autonomous, semi-autonomous, or human-supervised.

As used herein, a “certified” source, model, agent, validator, or workflow refers to one that satisfies one or more verification criteria, such as identity registration, provenance requirements, cryptographic integrity checks, policy approval, auditability thresholds, or consensus participation requirements.

As used herein, a “node” refers to any hardware unit capable of running at least part of the disclosed operating system or a containerized AI model and communicating with one or more remote systems or trust services. A node may be a server, a cluster of servers, a virtual machine, a container group, an individual processor, an industrial controller, an edge device, a vehicle-based compute platform, or another heterogeneous compute environment.

As used herein, a “distributed AI validator” refers to software, firmware, or hardware-assisted logic configured to independently evaluate one or more aspects of an AI operation, including but not limited to input provenance, model identity, model-state transition, replay result, policy compliance, audit integrity, resource-usage evidence, compensation evidence, or output consistency, and to contribute to a consensus determination regarding whether the AI operation should be accepted, promoted, anchored, compensated, or actioned.

In one illustrative combination of features, a computer-implemented method receives a definition for a world view object, generates a seed layer from one or more base queries, datasets, or model outputs, associates one or more real-time data streams or scheduled data-acquisition events with an input layer, normalizes received data into one or more persistent global data views, generates one or more inference outputs, assigns certainty or validation states to at least some of the inference outputs, promotes validated outputs to a trusted state layer, binds one or more controllers or agents to the world view object, stores the world view object as persistent state reusable across multiple workflows or queries, and creates a derived world view object by inheriting state from a plurality of stored world view objects.

Assigning certainty states may involve organizing inference outputs into ordered verification tiers associated with progressively higher validation requirements. Validation may include cross-model corroboration, provenance verification, deterministic rule checking, source certification, statistical testing, replay against versioned state, human review, validator consensus, or combinations thereof.

Automated action may be permitted only after a corresponding assertion has reached a required verification tier and is present in the trusted state layer. Governance rules may impose action limits, spending thresholds, risk escalation triggers, data provenance requirements, human-review requirements, validator quorum requirements, or other operational constraints. Such governance rules may be represented in any suitable machine-readable policy form, including a domain-specific governance language, system governance language, rules engine format, or equivalent deterministic ruleset.

The system may dynamically discover capabilities of a first artificial intelligence model through interface metadata and route output of the first artificial intelligence model as input to a second artificial intelligence model. Routing may occur at the granularity of a complete output, a selected portion of output, a feature, an embedding, a latent representation, a point, a neuron, or a layer representation.

At least part of a world view object may be maintained on an intermittently connected node. Local state updates and locally generated inference outputs may be synchronized with a remote node after connectivity is restored, and validated knowledge may be propagated from one node to one or more additional nodes. The system may further check an access entitlement or payment rule before granting access to a world view object or global data view, may maintain recursive or graph-based lineage among parent and derived world view objects, and may determine whether later requests can reuse prior validated state based on semantic similarity, correspondence metrics, validity intervals, change conditions, or requested historical time points.

Referring to FIG. 1, a representative high-level system architecture 100 includes a user interface and API gateway 110, an off-chain execution layer 120, a distributed resource layer 130, and a trust and identity layer 140. A request path 150 passes requests from the interface and gateway 110 to the execution layer 120. A verify-and-anchor path 160 links the execution layer 120 to the trust and identity layer 140. A provider resource path 170 links the distributed resource layer 130 to the execution layer 120. The execution layer 120 may host containerized models, controller runtime services, validator services, and state and resource management services.

Referring to FIG. 2, an interoperability arrangement 200 includes a first node 210 and a second node 220. The first node 210 includes an AI model 230. The second node 220 includes AI models 240 and 250. Path 260 represents output chaining between models, while interface 270 represents a neuron-level, feature-level, embedding-level, latent-level, point-level, or layer-level interface between heterogeneous models or model components.

Referring to FIG. 3, a request and orchestration flow 300 includes request submission step 310, gateway receive step 320, authentication step 330, world view object and global data view selection step 340, trusted-state sufficiency determination step 350, model or controller execution step 360, validation and governance step 370, persistent-state and audit update step 380, and response or authorized-action step 390. In some embodiments, one or more distributed validator consensus operations occur as part of step 370 or step 380.

Referring to FIG. 4, an identity and governance arrangement 400 includes a user identity 410, an agent identity 420, a model identity 430, world view object and global data view identities 440, an identity and trust service 450, governance rules and policies 460, access control and permissions 470, and an append-only audit log 480. In some embodiments, validator identities are also managed by the service 450. The service 450 may assign identifiers, authenticate actors, determine policy relationships, and support lineage, monetization, validation, and audit functions.

Referring to FIG. 5, a platform architecture 500 includes an ingestion and normalization layer 510, enterprise or external data sources 520, a world view object persistent state core 530, a governance and orchestration component 540, one or more global data views 550, user, agent, validator, and API interfaces 560, and multi-model execution services 570. Representative paths 521-526 indicate data flow, orchestration flow, and interaction among these components.

Referring to FIG. 6, a world view object stack 600 includes a persistent world view object 610 with a seed layer 620, an input layer 630, an inference layer 640, a validation layer 650, and a trusted state layer 660. Controllers or agents 670 may interact with one or more layers of the stack 600. Arrow 680 represents progression in certainty, validation, or both. Although the illustrated embodiment places trusted state at a deeper layer, any arrangement that preserves differentiated certainty and validation states is contemplated.

Referring to FIG. 7, a composition and inheritance arrangement 700 includes parent world view objects 710, 720, and 730, selected-state inheritance paths 740, a derived world view object 750, bound controllers or agents 760, and a reusable stored derived object 770. The derived world view object 750 may maintain lineage links to the parent objects, retain unresolved conflicts as competing assertions pending validation, and serve as a reusable starting context for later workflows.

The disclosed platform can be implemented as an AI operating system that sits between data ecosystems and AI execution systems. Rather than constructing context from scratch for each request, the platform maintains persistent state and governed access to that state. A request may therefore be serviced by selecting and updating one or more existing world view objects instead of re-fetching all underlying information.

In one embodiment, the platform includes an ingestion and normalization layer, a persistent state core, a governance and orchestration layer, a multi-model execution layer, an identity and trust layer, a validator layer or validator service mesh, and one or more access interfaces. Any of these components may be co-located or distributed. Any layer may run on one or more servers, clusters, edge devices, virtual machines, containers, or decentralized nodes.

The ingestion and normalization layer may include connectors for external APIs, enterprise resource planning systems, customer relationship management systems, market feeds, data lakes, lakehouse environments, document stores, industrial control systems, IoT systems, sensors, manually entered data, and outputs of other world view objects. The layer may support both pull-based ingestion and push-based ingestion. In some embodiments, the system schedules data acquisition according to volatility, policy, event triggers, or user-defined timing so that context is prepared before an agent requests it.

Normalization may include schema mapping, unit conversion, timestamp harmonization, source tagging, deduplication, confidence initialization, geospatial alignment, entity resolution, and context indexing. The normalized data can be written into one or more global data views and can also be attached directly to one or more world view objects. The persistent state core may maintain both current state and historical state so that a later workflow can reproduce what a given model, agent, validator, or controller saw at a particular point in time.

The governance and orchestration layer may enforce access control rules, certification requirements, action permissions, update schedules, event triggers, escalation rules, validator quorum rules, and compensation rules. The orchestration layer can determine when new data should be fetched, when inference should run, when validation should occur, when human review is required, when validator consensus is required, and when an output is sufficiently trusted to drive an automated action.

A multi-model execution layer may interface with multiple commercial, open-source, proprietary, or domain-specific AI systems. In some embodiments, the layer exposes queryable interfaces that describe model capabilities, required inputs, output formats, supported tools, internal granularity interfaces, and trust attributes. A controller or orchestrator can discover such capabilities dynamically and compose a workflow without hard-coding every model-to-model connection.

Execution environments may include containerized runtime infrastructure such as Kubernetes, OpenShift, Docker-based clusters, virtualized infrastructure, serverless environments, or equivalent execution frameworks. The execution layer may schedule jobs based on cost, latency, resource availability, certification requirements, geographic location, privacy policy, validator availability, or node connectivity.

In some embodiments, computational work is distributed across a decentralized physical infrastructure network in which resource providers contribute CPU resources, GPU resources, memory, storage, or specialized accelerators. Resource allocation, access entitlements, and compensation may be recorded in the operating system and, if desired, anchored to an immutable ledger. Distributed validator services may also operate over such a network.

The identity and trust layer may assign identifiers to users, agents, validators, models, world view objects, data assets, and workflows. An identifier may be human-readable, cryptographically bound, or anchored to a blockchain or equivalent trust service. In some embodiments, the trust anchor is a layer-one blockchain protocol that supports immutable digital identifiers. The identifier can be used to determine ownership, access control, provenance, responsibility for actions, validator role eligibility, and permitted monetization rules.

In some embodiments, a trust anchor is used for low-frequency, high-security operations, including identity registration, ownership tracking, access-rule registration, validator registration, and state anchoring. Periodically, the system may write cryptographic proofs, hashes, Merkle roots, or equivalent integrity evidence of off-chain state, audit state, or model state to the trust anchor so that the lifecycle of models, agents, workflows, and world view objects remains verifiable.

The audit subsystem may record state transitions, data mutations, model versions, training events, inference events, validation outcomes, consensus outcomes, payment events, access events, workflow executions, resulting actions, and compensation events. Records may be stored directly in an immutable ledger, in an anchored non-changeable audit log, or in another verifiable append-only record system. In some embodiments, each record is hash-chained with one or more prior records to reveal tampering.

A world view object may be created for any scope of interest. By way of example, a world view object may correspond to an oil market, a battery asset, a fleet of vehicles, an industrial production line, a logistics region, a customer portfolio, a healthcare service line, a cybersecurity environment, an enterprise policy regime, or a temporary mission context defined for a specific task. At creation time, the system can receive a seed definition specifying base queries, seed datasets, enterprise records, or outputs from one or more external or internal models.

The seed layer may include summarized facts, extracted entities, baseline hypotheses, structural relationships, embeddings, graph links, policy baselines, and references to source materials. The seed layer is not limited to textual outputs and may include numerical, symbolic, graph-based, image-derived, sensor-derived, or multimodal outputs. In some embodiments, initial base queries executed against one or more foundation models provide semantic seeding for the world view object.

The input layer may extend the seed layer with live sensor streams, event feeds, application logs, telemetry, market quotes, schedule-driven internet queries, enterprise database updates, tool outputs, human annotations, and outputs from other world view objects. In an illustrative battery embodiment, the input layer may ingest thermocouple readings, voltage measurements, amperage measurements, flow measurements, energy-storage values, ambient conditions, maintenance records, and external market or operating constraints, thereby maintaining a persistent battery-state world view object that spans both physical telemetry and contextual operating knowledge.

The inference layer may be populated by one or more models executing on the normalized inputs and the existing state of the world view object. Inference outputs may include predictions, classifications, anomaly detections, explanations, hypotheses, recommended actions, confidence scores, or reasoning traces generated by one or more controllers. Multiple inference sub-layers may exist. For example, a first inference layer can generate broad hypotheses from uncertified feeds, while a later inference layer refines those hypotheses using certified sources, domain-specific models, deterministic analytics, validator feedback, or replay logic.

The validation layer can evaluate inference outputs using cross-model corroboration, source certification, ledger-backed provenance, statistical tests, policy checks, constraint evaluation, replay against historical state, digital signatures, validator consensus, or human review. Each assertion may therefore carry explicit metadata describing why the assertion is believed, how it was derived, what sources influenced it, whether consensus was reached, and whether it is safe to use for downstream action. The trusted state layer stores higher-certainty assertions and action gates. In some embodiments, only information that has passed specified validation thresholds is promoted into the trusted state layer.

In certain embodiments, the validation layer includes distributed AI validators deployed across multiple nodes. Each validator may independently evaluate one or more of input provenance, model identity, model version, training-state transition, parameter-change evidence, replay consistency, cryptographic proofs, policy compliance, source lineage, compensation evidence, or resource-consumption evidence. A proposed inference result, model update, workflow action, compensation event, or audit mutation may be accepted only after a consensus threshold is satisfied among the participating validators.

The validator consensus mechanism may be implemented using threshold voting, weighted quorum logic, Byzantine fault-tolerant consensus, stake-weighted consensus, reputation-weighted consensus, deterministic rules, or combinations thereof. Consensus inputs may include validator attestations, cryptographic proofs, audit records, replay results, lineage graphs, resource-use measurements, data-source hashes, and policy-evaluation outputs. The consensus mechanism can be used to detect or prevent cheating, including falsified computation, fabricated or withheld updates, collusive validation, poisoned model changes, falsified resource reports, fabricated compensation claims, model-state tampering, replay mismatches, or fabricated audit entries.

In some embodiments, validator logic is applied not only to output assertions but also to the learning process itself. Training events, fine-tuning events, reinforcement updates, and other learning-state transitions may be documented in the audit subsystem or on a blockchain. Validators may use such records to validate the source of data used to set or influence neuron values, latent states, weights, routing logic, or policy thresholds, thereby supporting confidence assignment within the system and providing forensic-grade learning lineage.

Controllers and agents may be bound to a world view object at creation time or later. A bound controller may have a role such as ingestion controller, validation controller, action controller, market analyst agent, battery diagnostics agent, maintenance planner agent, compliance agent, meta-agent, supervisor agent, worker agent, or janitorial agent. Each controller can be granted different permissions against different layers of the world view object. Controllers may communicate through the world view object rather than only through direct message passing, enabling multiple agents to share synchronized persistent state without independently reconstructing context from raw sources.

In certain embodiments, the operating system includes an agentic kernel or cognitive orchestrator. In a traditional operating system, a kernel arbitrates access to CPU cycles and memory address spaces. In the disclosed AI operating system, the cognitive orchestrator may additionally arbitrate access to reasoning capacity, context windows, tool access, model routes, validation routes, and distributed services. The orchestrator may decompose high-level goals into sub-goals, assign those sub-goals to selected agents, route validation tasks to validators, and schedule use of distributed resources according to capability, latency, cost, risk, privacy, or certification requirements.

A dynamic agent mesh may permit on-the-fly service composition among agents and models. Through queryable interfaces, an agent may discover the capabilities, accepted input formats, output semantics, certainty status, pricing terms, and policy constraints of another agent or model. Such agent-mesh composition can occur without prior hardcoding. In some embodiments, the orchestrator uses a system governance language or other rule representation as a machine-readable constitution for controlling actions, spending, escalation, and provenance requirements.

Global data views can provide a persistent substrate shared by multiple world view objects. A global data view may be updated asynchronously from any particular query cycle according to a schedule or in response to an event. Parameterized access can be supported at the global data view layer so that a controller may request only data for a defined time range, region, entity, source, asset class, device group, policy regime, or frequency band. Updates to a global data view may be versioned so that later review can map an output back to the particular view version, source set, and validation metadata that existed when the output was generated.

Identity management may be applied at multiple levels. A user identity can define who is making a request. An agent identity can define which controller is acting. A validator identity can define which validator participated in a consensus decision. A model identity can define which model version generated a particular output. A world view object identity can define ownership, access scope, lineage, and policy bindings for the state object itself. The identity system can be combined with access control rules, subscription rules, monetization rules, jurisdiction-specific policies, and validator-eligibility rules.

Certified data sources may be managed differently from non-certified sources. For a certified source, the operating system may track each modification, apply hashing or equivalent integrity checks, and record change events in a blockchain or immutable log. For a non-certified source, the system may still store interface metadata and fetched content, but can assign a lower starting confidence or require corroboration. The platform may also record learning-process lineage, including source data, training parameters, timing, resource environment, resulting model version, validator participation, and validation status of a training event.

The platform supports interoperability among heterogeneous AI models. A first model can expose an output interface whose output becomes an input to a second model. Interoperability can occur at different granularities. At one level, the complete output of one model may be chained into another model. At another level, a selected subset of outputs, embeddings, features, or latent representations may be routed into downstream processing. In still further embodiments, a point, neuron, feature map, layer, or other internal parameterization of one model may be interfaced to another model or implementation. This architecture enables recursive model nesting and composite intelligence.

The disclosed operating system may execute across a distributed network of nodes. A node may be a server, a cluster of servers, a virtual machine, a container group, an individual processor, an edge device, a vehicle-based compute platform, an industrial controller, or any other compute environment capable of maintaining or servicing at least part of the operating system. Nodes may connect and disconnect while preserving useful operation. A local node can continue to process local data and maintain local portions of a world view object while disconnected, and upon reconnection may synchronize its updates, audit records, learned state, validator evidence, or compensation evidence with a parent node, peer node, or central state core.

In some embodiments, locally generated inference outputs from a plurality of nodes are aggregated into a shared persistent state accessible to multiple world view objects. A fleet-level or enterprise-level world view object may therefore be derived in part from validated local outputs created across multiple vehicles, devices, or industrial sites. Synchronization may also propagate validated knowledge from one node to additional nodes to improve later inference operations.

The orchestration engine may control the interaction timing between live data feeds, scheduled updates, agent execution, validation, and action. Instead of waiting for a user to ask a question, the engine can proactively maintain relevant world view objects and global data views so that downstream agents operate on prepared context. Scheduling can depend on data volatility, source cost, risk classification, regulatory windows, device condition, market hours, user subscriptions, or other operational parameters. In some embodiments, the engine determines whether a later request can be satisfied using previously validated state without retrieving new external data, and otherwise refreshes or reconstructs the necessary state.

Historical-state replay and reconstruction may be supported at the world view object level and the global data view level. If a user, agent, validator, auditor, or regulator requests the state corresponding to a selected time point, the system may reconstruct the earlier state using stored historical data, version references, lineage, and validation metadata. Such reconstruction may be used for replay analysis, dispute resolution, regulatory review, or safe action authorization.

The operating system may optionally include a monetization layer. Owners of models, agents, or data views may define access terms such as subscription plans, per-use charges, usage credits, enterprise entitlements, validator compensation rules, or resource-provider compensation rules. Access decisions can be checked before an agent or user receives results. In some embodiments, payments or settlements are handled by a payment service or universal payment agent capable of converting among internal credits, fiat-denominated prices, native tokens, stable-value instruments, or other supported payment forms. The universal payment agent may perform cross-rail conversion, bridging, settlement, or credit allocation.

A significant feature of the present disclosure is the ability to derive a new world view object from one or more parent world view objects. Selected portions of parent state may include facts from a trusted layer, pending hypotheses from an inference layer, relevant source links, controller bindings, validator metadata, policy constraints, embeddings, graph structures, or references to associated global data views. When multiple parent objects contain overlapping or conflicting state, the operating system may apply conflict-resolution logic based on recency, certainty level, validation history, source certification, owner policy, user privileges, jurisdiction, or explicit merge rules. Unresolved conflicts may be retained as competing assertions pending validation.

The derived world view object may then be expanded with new context, new inputs, and new task-specific controllers. Because lineage to the parents is preserved, later reviewers can determine which parent states influenced the derived object and which subsequent updates were introduced only in the derived object. A derived world view object may itself be stored as a reusable starting world view object. Accordingly, world view objects can form a composable hierarchy or directed graph of reusable AI state packages.

In one illustrative market-intelligence embodiment, the system maintains a persistent oil-market global data view that is updated from external pricing feeds, enterprise records, shipping information, and curated news sources. A market world view object references that global data view and includes inference layers produced by one or more analytical models and large language models. Certified analyst agents may query the trusted state layer for alerting or decision support while other agents continue to enrich lower layers. Validator consensus may be used before automated trading support actions, alert escalations, or monetized redistribution of results.

In one illustrative vehicle embodiment, edge nodes on one or more vehicles ingest camera feeds, geolocation, and telemetry into local world view objects. Local inference may identify objects and distances. A remote cluster may aggregate fleet-level learnings, validate new models, and distribute updated models or trusted assertions back to the vehicles. Connectivity interruptions do not prevent local operation because the relevant world state is maintained locally and synchronized later. Distributed validators may review the learning process, model updates, and vehicle-generated inference packages before those outputs are accepted into the fleet-level state.

In one illustrative enterprise-governance embodiment, a compliance world view object is derived from a market-state object, a customer-state object, and a policy-state object. The derived object inherits selected state from each parent and binds a certified compliance controller. The controller can refuse actions that do not satisfy trusted-state requirements or that violate access restrictions. Validator consensus may be required for high-risk actions or for promotion of a compliance conclusion into the trusted state layer.

Additional validation analytics may monitor alignment of model-state trajectories to requested intent, entropy or uncertainty in decision distributions, dimensional hierarchy across verification tiers, or mathematical consistency measures such as signal decomposition or transform-based checks including Walsh-Rademacher or related transforms. These analytics may be used as optional validation inputs, may influence confidence scores, and may inform whether additional human review or validator consensus is required.

The disclosed subject matter is not limited to the particular hardware, model providers, data providers, validator arrangements, or ledger technologies described herein. Different embodiments may omit blockchain anchoring, may use different validation mechanisms, may use different controller architectures, may use different consensus mechanisms, or may combine some layers in a different arrangement. Although certain examples refer to large language models, the platform is equally applicable to other machine-learning systems, neural networks, simulation engines, deterministic analytics, retrieval systems, multimodal systems, and hybrid model stacks.

The present disclosure therefore provides a unified AI operating system that encapsulates context as persistent world view objects, composes and inherits such objects across tasks, governs access through identity and policy, supports verifiable execution across distributed and intermittently connected environments, and uses distributed validator consensus to preserve the integrity of AI operations and to detect or prevent cheating behavior.

1. A computer-implemented method comprising:
A. Maintaining, by one or more processors, a persistent world view object associated with a domain, asset, device, process, market, enterprise state, or combination thereof,
a. the persistent world view object comprising:
i. a persistent memory structure configured to store normalized data and inference outputs;
ii. a validation structure configured to record validation states or certainty tiersa lineage tracking structure configured to maintain relationships between prior and derived state;
iii. a versioned state container configured to support reconstruction of prior system state and an execution capability structure configured to store, reference, or invoke one or more functions, workflows, agents, or automated actions associated with the persistent world view object;
b. Updating the persistent world view object by:
i. receiving data from one or more data sources, outputs of one or more artificial intelligence models, or derived inferences, and
ii. allocating processing resources and managing memory operations to incorporate the received data into the persistent world view object;
B. Generating one or more inference outputs using at least part of the persistent world view object;
C. Validating at least one of the inference outputs by:
a. applying one or more validation rules or verification procedures to the inference output; and
b. promoting the inference output to a trusted state when a validation condition is satisfied; and
c. submitting the inference output to one or more distributed validator systems and authorizing the inference output for use only when a validation threshold or consensus condition is satisfied.
D. Storing the persistent world view object as persistent state reusable across multiple later queries or workflows;
a. maintaining the persistent world view object in allocated memory accessible to one or more computing nodes;
b. preserving locally stored state during interruption of connectivity between at least one computing node and a remote system; and
c. synchronizing the locally stored state with the remote system upon restoration of connectivity;
E. Using at least part of the persistent world view object or the one or more inference outputs to satisfy a later query, workflow, or automated action without reconstructing all context from raw sources for the later query, workflow, or automated action, thereby reducing processor utilization, memory access operations, or network communication required to generate the later query, workflow, or automated action;
a. verifying an identity associated with a user, agent, or system component requesting the later query, workflow, or automated action; and
b. permitting the later query, workflow, or automated action only when an authorization condition is satisfied;
F. Initiating a workflow, task, or automated action in response to at least one of:
a. scheduled execution time;
b. detection of a state condition within the persistent world view object; or
c. receipt of an event signal from a computing node, data source, or monitoring system.
G. Recording at least one system event associated with the persistent world view object by:
a. generating an audit record describing at least one of a state transition, validation outcome, inference output, workflow execution, authorization decision, or resource allocation event; and
b. storing the audit record in an append-only or immutable data store configured to preserve a verifiable history of system operations.
H. Maintaining lineage information for the persistent world view object that identifies relationships between prior states and derived states of the persistent world view object.
I. Maintaining lineage information for the persistent world view object that identifies relationships between prior states and derived states of the persistent world view object, wherein:
J. a. the persistent world view object is associated with a unique identifier configured to permit addressing, retrieval, or reference to the persistent world view object by one or more users, agents, workflows, or system components; and
K. b. the persistent world view object is configured to contain, reference, inherit state from, or invoke one or more abilities of one or more additional world view objects.
L. Enforcing one or more governance rules associated with the persistent world view object by:
a. evaluating at least one rule defining an operational constraint, authorization condition, threshold value, or policy requirement associated with the persistent world view object; and
b. permitting or preventing execution of a workflow, task, or automated action based on whether the evaluated rule is satisfied.

2. The method of claim 1, further comprising assigning validation states or certainty states to at least some of the one or more inference outputs, wherein assigning the validation states or certainty states comprises organizing the one or more inference outputs into ordered verification tiers, and wherein an automated action is permitted only when a corresponding assertion satisfies an action-authorization condition associated with a trusted state layer.

3. The method of claim 1, further comprising evaluating one or more programmable governance rules before permitting execution of an action initiated by a controller or agent, the programmable governance rules including at least one of action limits, spending thresholds, risk-escalation triggers, or data-provenance requirements.

4. The method of claim 1, wherein at least one of the persistent world view object or one or more persistent global data views is updated asynchronously from a current user query according to a schedule, an event trigger, a volatility metric, a risk classification, or a policy rule.

5. The method of claim 1, further comprising designating at least one data source as a certified data source, tracking modifications to data from the certified data source, and recording integrity information for the tracked modifications in an immutable or append-only audit record anchored to a blockchain or other immutable ledger.

6. The method of claim 1, further comprising validating the one or more inference outputs using one or more of cross-model corroboration, human review, deterministic rule checking, provenance verification, statistical testing, replay against versioned state, source certification, digital signature verification, or consensus analysis.

7. The method of claim 1, further comprising dynamically discovering capabilities of a first artificial intelligence model through interface metadata and routing an output of the first artificial intelligence model as an input to a second artificial intelligence model, wherein the routing occurs at a granularity comprising a complete output, a feature, an embedding, a latent representation, a neuron, a point, or a layer representation.

8. The method of claim 1, wherein at least part of the world view object is maintained on an intermittently connected node, and further comprising synchronizing local state updates and locally generated inference outputs with a remote node after connectivity is re-established and aggregating inference outputs from a plurality of nodes into a shared persistent state accessible to multiple world view objects.

9. The method of claim 1, further comprising checking an access entitlement or payment rule before permitting a user, agent, or workflow to access at least a portion of the persistent world view object or one of one or more persistent global data views, wherein payment processing is performed at least in part by a payment agent configured to perform cross-rail conversion, bridging, settlement, token swapping, or credit allocation.

10. The method of claim 1, further comprising binding one or more controllers or agents to the persistent world view object, wherein the one or more controllers or agents comprise an orchestrator or cognitive kernel configured to manage a plurality of agent classes including strategic agents, supervisory agents, worker agents, or maintenance agents, and to route tasks among the plurality of agent classes through a dynamic agent mesh.

11. The method of claim 1, wherein creating the derived world view object comprises selecting multiple parent world view objects, importing selected state from at least two of the multiple parent world view objects, maintaining lineage links in a directed graph among parent and derived world view objects, storing the derived world view object as a reusable starting world view object, and resolving or retaining conflicting inherited assertions according to one or more merge policies.

12. The method of claim 1, further comprising determining whether a subsequent request can be satisfied using previously validated state based on a semantic similarity or correspondence metric, a validity interval, a change condition, or a requested historical time point, and in response to a failure of a reuse condition, invalidating, refreshing, or reconstructing the previously validated state.

13. The method of claim 1, further comprising validating the one or more inference outputs by submitting at least one artificial-intelligence operation to a plurality of distributed AI validators that independently evaluate one or more of lineage, provenance, replay results, cryptographic proofs, policy compliance, resource-consumption data, or model-state transitions, and promoting or authorizing the at least one artificial-intelligence operation only when a consensus threshold is satisfied, thereby detecting manipulated, inconsistent, or cheating behavior.

14. A system comprising:
A. one or more processors; and
B. one or more non-transitory memories storing instructions that, when executed by the one or more processors, cause the system to perform operations comprising:
1. create and maintain at least one persistent world view object comprising:
a. a persistent memory structure configured to store normalized data and inference output(s);
b. a validation data structure configured to record validation states or certainty tiers;
c. a lineage tracking structure configured to maintain relationships between prior and derived state; and
d. a versioned state container configured to support reconstruction of prior system state;
e. another instance of a persistent world view object;
2. update the persistent world view object by:
a. receiving data from one or more data sources or artificial intelligence models; and
b. allocating processing and memory resources to incorporate the received data into the persistent world view object;
3. generate one or more inference outputs using at least part of the persistent world view object;
4. validate at least one inference output according to one or more validation rules and authorize use of the inference output when a validation condition is satisfied;
5. synchronize locally stored state with at least one remote computing node upon restoration of connectivity;
6. record at least one system event associated with the persistent world view object in an append-only or immutable audit record; and
7. reuse the persistent world view object or the one or more inference outputs across multiple later queries or workflows without independently reconstructing all context from raw sources.

15. The system of claim 14, further comprising an identity and trust layer configured to:
A. assign identifiers to one or more of users, agents, models, workflows, data assets, global data views, or world view objects;
B. verify an identity associated with a system request prior to permitting execution of a workflow, task, or automated action; and
C. anchor audit history or periodic cryptographic proofs of off-chain state to a blockchain or other immutable ledger in response to occurrence of a system event.

16. The system of claim 14, wherein the system is configured to:
A. select and assign computational work across a distributed physical infrastructure network comprising heterogeneous resource-provider nodes based on one or more of hardware capability, resource availability, geographic proximity, privacy requirement, certification requirement, or historical performance; and
B. calculate a compensation value for at least one resource provider based on one or more measurable workload characteristics.

17. The system of claim 14, wherein the system is configured to determine a compensation value for at least one resource provider based on one or more measurable workload characteristics including compute duration, resource utilization, validation participation, or service availability.

18. The system of claim 14, wherein a plurality of controllers or agents share synchronized access to the at least one persistent world view object or to one or more persistent global data views without independently reconstructing context from raw sources, and wherein a monetization subsystem is configured to enforce one or more subscription rules, per-use rules, usage-credit rules, payment rules, or entitlement rules.

19. The system of claim 14, further comprising a validator subsystem including a plurality of distributed AI validators configured to independently evaluate an artificial-intelligence operation and participate in a consensus mechanism before acceptance of a model update, training-state transition, inference result, automated action, resource-compensation event, or audit-state mutation, thereby detecting or preventing falsified computation, collusive outputs, tampered model state, fabricated audit entries, or other cheating behavior.

20. One or more non-transitory computer-readable media storing instructions that, when executed by one or more processors, cause a computing system to perform operations comprising:
A. Maintain a persistent world view object representing machine-maintained state for an artificial intelligence system;
B. Update the persistent world view object using one or more data sources, outputs of one or more artificial intelligence models, or derived inferences; and
C. Use the persistent world view object to satisfy multiple later queries or workflows without reconstructing all context from raw sources for each of the multiple later queries or workflows.
